(19) United States
(12) Patent Application Publication
(10) Pub. No.: US 2024/0174932 A1
(43) Pub. Date: May 30, 2024

(54) METHOD AND APPARATUS FOR TIRE RECYCLING

(71) Applicant: GLOBAL ENVIRO HOLDING PTE. LTD., Singapore (SG)

(72) Inventor: George PASKALOV, Torrance, CA (US)

(21) Appl. No.: 17/793,956

(22) PCT Filed: Jan. 6, 2022
(86) PCT No.: PCT/SG2022/050007

§ 371 Date: Jul. 20, 2022

(51) Int. Cl. C10J 3/72; C01B 32/05

(52) U.S. Cl. CPC C10J 3/72; C01B 32/05; C10J 2300/0946; C10J 2300/1238; C10J 2300/1643

(57) ABSTRACT

A method of tire recycling, the method comprising the steps of:
a) a hybrid plasma torch comprising an arc plasma torch and a radio frequency (RF) plasma torch generating a plasma jet in a first direction;
b) injecting rubber powder obtained from comminuting waste tires into the plasma jet in a second direction against the first direction and obtaining a synthesis gas (syngas) by plasma pyrolysis of the rubber powder;
c) heating unpyrolyzed rubber powder remaining after step b) in a low frequency (LF) induction heater to obtain carbon black; and
d) using a portion of the obtained syngas as plasma gas by the hybrid plasma torch.

### TECHNICAL FIELD

This invention relates to a method and apparatus for tire recycling that generates a synthesis gas and carbon black.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Cities and industries around the world are searching for environmentally friendly solutions to their waste tire management problems instead of the usual methods of burning waste tires in a furnace or increasing scrap tire land fill sites. One proposed solution is to use pyrolysis systems, which involves the thermochemical decomposition of organic materials at elevated temperatures in the absence of oxygen (or any halogen).

The majority of current plasma pyrolysis systems use plasma arc technology which uses two electrodes, usually made of consumable carbon, which has electricity passed through them to produce hot arc plasma between them. These electrodes require frequent replacement and the electrode design is limited in its configurations and parameters. Such a method also produces health and environmental hazards through the production of waste products. Another plasma pyrolysis system uses a radio frequency (RF) plasma torch. However, RF plasma systems require use of argon and nitrogen as a special plasma gas, wherein the high cost of argon gas raises the cost of using RF plasma for tire pyrolysis.

### SUMMARY

According to a first aspect, there is provided a method of tire recycling, the method comprising the steps of:
a) a hybrid plasma torch comprising an arc plasma torch and a radio frequency (RF) plasma torch generating a plasma jet in a first direction;
b) injecting rubber powder obtained from comminuting waste tires into the plasma jet in a second direction against the first direction and obtaining a synthesis gas (syngas) by plasma pyrolysis of the rubber powder;
c) heating unpyrolyzed rubber powder remaining after step b) in a low frequency (LF) induction heater to obtain carbon black; and
d) using a portion of the obtained syngas as plasma gas by the hybrid plasma torch.

The method may further comprise collecting the syngas for electricity generation.

The method may further comprise collecting the carbon black for tire production.

The method may further comprise a turbine generating electricity from the obtained syngas.

A portion of the electricity generated may be used to power the method.

According to a second aspect, there is provided an apparatus for tire recycling, the apparatus comprising: a reaction chamber having a gas outlet; a hybrid plasma torch provided in the reaction chamber and configured to generate a plasma jet in a first direction in the reaction chamber, the hybrid plasma torch comprising an arc plasma torch and a radio frequency (RF) plasma torch; at least one feeding tube in fluid communication between the reaction chamber and a powder injector for injection of rubber powder obtained from comminuting waste tires into the plasma jet in a second direction against the first direction to obtain a synthesis gas (syngas) by plasma pyrolysis of the rubber powder; a low frequency (LF) heater in fluid communication with the reaction chamber for heating unpyrolyzed rubber powder that is flowed from the reaction chamber into the low frequency induction heater to obtain carbon black; wherein the hybrid plasma torch uses a portion of the obtained syngas as a plasma gas.

The apparatus may further comprise a syngas collector in fluid communication with the gas outlet.

The syngas collector may further comprise a turbine configured to use the syngas for electricity generation.

The apparatus may be powered by a portion of electricity generated from the obtained syngas.

The apparatus may further comprise a carbon black collection channel in fluid communication with the LF induction heater.

The LF induction heater may comprise at least one tubular conduit having a LF induction coil provided around the tubular conduit.

The tubular conduit may extend outwardly from the reaction chamber at a downward angle.

The tubular conduit may be rotatable about its own longitudinal axis.

The apparatus may further comprise an auger rotatably provided within the tubular conduit to facilitate movement of material along the tubular conduit.

The tubular conduit may be made of an inductively heatable material.

Alternatively, the auger may be made of an inductively heatable material, wherein the tubular conduit is made of a material that allows the LF induction coil to inductively heat the auger without inductively heating the tubular conduit, and wherein the tubular conduit provides heat insulation to minimize heat loss from the auger through the tubular conduit.

For both aspects, an angle between the second direction and the first direction ranges from 0° to 45°.

### BRIEF DESCRIPTION OF DRAWINGS

In order that the invention may be fully understood and readily put into practical effect there shall now be described by way of non-limitative example only exemplary embodiments of the present invention, the description being with reference to the accompanying illustrative drawings, in which:

FIG. 1 is a flowchart of an exemplary embodiment of a method of tire recycling and gas generation.

FIG. 2 is a schematic illustration of an exemplary embodiment of an apparatus for tire recycling and gas generation.

FIG. 3 is a schematic illustration of an exemplary embodiment of a tubular conduit of the apparatus of FIG. 2.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

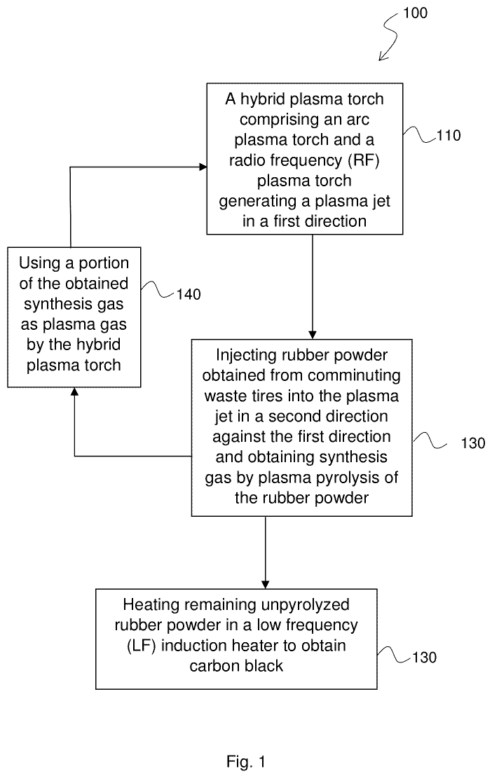

Exemplary embodiments of a method (100) and apparatus 200 for tire recycling will be described below with reference to FIG. 1 to FIG. 3.

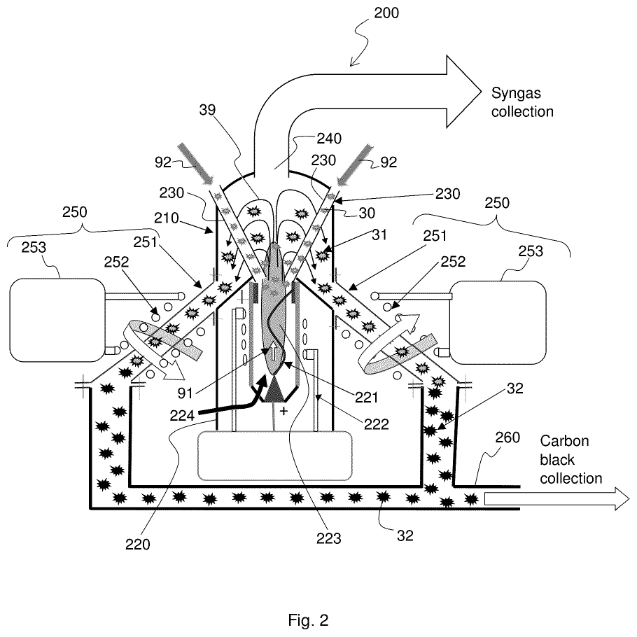

The apparatus 200 comprises a reaction chamber 210 in which a hybrid plasma torch 220 is provided. In an exemplary embodiment as shown in FIG. 2, the hybrid plasma torch 220 is provided centrally within the reaction chamber 210. The hybrid plasma torch 220 comprises an arc plasma torch 221 and a radio frequency (RF) plasma torch 222, and generates a plasma jet 223 in a first direction 91 (110) for pyrolyzing rubber powder 30. The arc plasma torch 221 may comprise a DC plasma torch, for example. Generation of the plasma jet 223 is achieved by passing a plasma gas 224 through the arc plasma torch 221 and subjecting the plasma gas 224 that has passed through the arc plasma torch 221 to a RF field provided by the RF plasma torch 222. As the hot plasma jet 223 is formed by passing the plasma gas 224 through both an electric arc (provided by the arc plasma torch 221) and an RF induction coil (provided by the RF plasma torch 222), different plasma gases may be used to control the resulting plasma jet 223 formed in order to increase efficiency of the rubber powder pyrolysis.

In the method (100), rubber powder 30 obtained from comminuting waste tires is injected into the plasma jet 223 in a second direction 92 against the first direction 91 (120), so that there is effectively a counterflow of the injected rubber powder 30 relative to the plasma jet 223. An angle between the second direction 92 and the first direction 91 may range from 0° to 45°. For example, where the angle between the second direction 92 and the first direction 91 is 0°, this means that the direction of flow of injected rubber powder 30 is directly opposite to the direction of flow of the plasma jet 223. In this way, pyrolysis of the rubber powder 30 is achieved with increased efficiency due to increase in heat exchange between the plasma jet 223 and the rubber powder 30 that are flowing in substantially opposite directions. This method of powder feeding is not sensitive to particle size as both smaller and larger particles automatically have different flight duration and processing time in the plasma jet 233, thereby making the pyrolysis more uniform and efficient.

Injection of the rubber powder 30 into the plasma jet 223 may be effected through at least one feeding tube 230 provided in the apparatus 200, the feeding tube 230 being in fluid communication between the reaction chamber 210 and a powder 30 injector (not shown). As the rubber powder 30 is pyrolyzed by the plasma jet 223, a synthesis gas (syngas) is obtained which comprising predominantly of carbon monoxide and hydrogen. Carbon dioxide and long-chain hydrocarbons may also be present. The obtained syngas is exhausted from the reaction chamber 210 through a gas outlet 240 provided in the reaction chamber 210. In an exemplary embodiment of the apparatus 200 as shown in FIG. 2, the gas outlet 240 may be provided at the top of the reaction chamber 210.

In the reaction chamber 210, pyrolysis of the rubber powder 30 takes place in an oxygen-starved and high heat atmosphere that prevents the production of dioxins, furans, and other hazardous by-products from being produced. Also, composition of the obtained syngas is affected not only by the reaction temperature of the pyrolysis but also the process dwell time, type of plasma gas and type of carrier gas. Varying these parameters provides the method (100) and apparatus 200 with the ability to produce a range of quantities of various output constituents.

Appreciably, not all of the rubber powder 30 that is injected into the plasma jet 223 will be pyrolyzed. In the method (100) and apparatus 200, remaining unpyrolyzed rubber powder 31 is heated in a low frequency (LF) induction heater 250 (130) of the apparatus 200 to obtain carbon black 32. The LF induction heater 250 preferably comprises at least one tubular conduit 251 in fluid communication with the reaction chamber 210, and an LF induction coil 252 provided around the tubular conduit 251. The LF induction coil 252 is connected to a LF generator 253. Frequency of the LF induction heater 250 may be between 1 kHz and 500 kHz while the power used may be between 10 kW and 5 MW.

In the exemplary embodiment of the method (100) and apparatus 200 as shown in FIGS. 1 and 2, the first direction 91 in which the plasma jet 223 is generated is vertically upwards. Rubber powder 30 is injected downwardly at an angle of about 20° to the vertical into the plasma jet 223. Remaining unpyrolyzed rubber powder 31 follows a movement trajectory that goes first upwards and then downwards, as indicated by arrows 39 in FIG. 2. The tubular conduit 251 of the LF induction heater 250 extends outwardly from the reaction chamber 210 at a downward angle to allow the unpyrolyzed rubber powder 31 to flow under gravitational pull into the LF induction heater 250. This creates a fluidized bath to allow and increase the variation of dwell time of the unpyrolyzed rubber powder 31 in the apparatus 200. Increase in the dwell time breaks down any heavy oils leaving the plasma torch 220 into long chain hydrocarbon gases, thereby increasing the heating value of the obtained syngas when producing energy from waste tires.

In the tubular conduit(s) 251, radiation and convection take place to heat passing gases, liquids and solids and temperature in the tubular conduit 251 may be as high as 900° C. and beyond. In a first exemplary embodiment, the tubular conduit 251 may be made of an appropriate material that can be inductively heated, such as stainless steel or carbon steel, and may be coated with ceramic, graphite or any other magnetic material to allow induction to take place. The tubular conduit 251 may further be rotatable about its own longitudinal axis to increase the efficiency of induction heating of the tubular conduit 251.

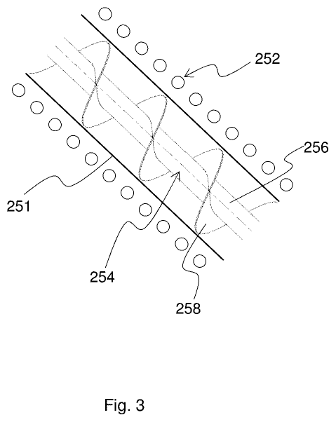

In some embodiments, the apparatus 200 may further comprise an auger 254 as shown in FIG. 3 comprising a shaft 256 with a broad helical blade or flighting 258 rotatably provided within the tubular conduit 251 to facilitate movement of material such as the unpyrolyzed rubber powder 31 and the obtained carbon black 32 along the tubular conduit 251.

In a second exemplary embodiment of the apparatus 200, the auger 254 may be made of an inductively heatable material such as a magnetic material, while the tubular conduit 251 is made of a material such as a dielectric material that allows the electromagnetic field from the LF induction coil 252 to inductively heat the auger 254 without inductively heating the tubular conduit 251, i.e., the tubular conduit 251 itself is transparent to the electromagnetic field from the LF induction coil 252. In the second exemplary embodiment, the material of the tubular conduit 251 is preferably also heat insulating so that all the heat generated by induction heating of the auger 254 remains within the tubular conduit 251 with minimal heat loss to the surroundings, thereby maximizing the induction heating efficiency for conversion of the unpyrolyzed rubber powder 31 to carbon black 32.

In some embodiments, the LF induction heater 250 may comprise a plurality of the tubular conduit 251 described above, each provided with an LF induction coil 252 for more efficient conversion of the unpyrolyzed rubber powder 31 into carbon black 32. In such embodiments, each tubular conduit 251 may or may not be provided with a rotatable auger 254 therein.

In the method (100) and apparatus 200, a portion of the obtained syngas is used as plasma gas 224 by the hybrid plasma torch 220 (140). The remaining syngas may be cooled down, purified and supplied to a turbine (may be a gas turbine or a steam turbine) in order to produce electricity. In some embodiments, a portion of the generated electricity may be used to power the method (100) and apparatus 200 so that the system is self-sustained. The remaining generated electricity may be sold or channeled for other uses.

The carbon black 32 obtained by the method (100) may be channeled from the LF induction heater 250 via a carbon black collection channel 260 in fluid communication with the LF induction heater 250 to be collected for future use as a component for manufacturing new tires.

Using the above described combination of hybrid high temperature plasma and low frequency induction heating, efficiency of the rubber powder pyrolysis and syngas generation is dramatically improved. By using a portion of the obtained syngas as the plasma gas in the hybrid plasma torch 220, cost of plasma generation is significantly reduced as no costly argon or other noble gases are required. Energy-wise, the method (100) and apparatus 200 can also be rendered self-sustaining by using a portion of the electricity generated from the obtained syngas to power the apparatus 200 and method (100).

While there has been described in the foregoing description exemplary embodiments of the present invention, it will be understood by those skilled in the technology concerned that many variations in details of design, construction and/or operation may be made without departing from the present invention.

1. A method of tire recycling, the method comprising the steps of:
a) generating a plasma jet in a first direction using a hybrid plasma torch comprising an arc plasma torch and a radio frequency (RF) plasma torch;
b) injecting rubber powder obtained from comminuting waste tires into the plasma jet in a second direction against the first direction and obtaining a synthesis gas (syngas) by plasma pyrolysis of the rubber powder;
c) heating unpyrolyzed rubber powder remaining after step b) in a low frequency (LF) induction heater to obtain carbon black; and
d) using a portion of the obtained syngas as plasma gas by the hybrid plasma torch.

2. The method of claim 1, further comprising collecting the syngas for electricity generation.

3. The method of claim 1, further comprising collecting the carbon black for tire production.

4. The method of claim 1, wherein an angle between the second direction and the first direction ranges from 0° to 45°.

5. The method of claim 1, further comprising: e) a turbine generating electricity from the obtained syngas.

6. The method of claim 5, wherein a portion of the electricity generated in step e) is used to power the method.

7. An apparatus for tire recycling, the apparatus comprising:
a reaction chamber having a gas outlet;
a hybrid plasma torch provided in the reaction chamber and configured to generate a plasma jet in a first direction in the reaction chamber, the hybrid plasma torch comprising an arc plasma torch and a radio frequency (RF) plasma torch;
at least one feeding tube in fluid communication between the reaction chamber and a powder injector for injection of rubber powder obtained from comminuting waste tires into the plasma jet in a second direction against the first direction to obtain a synthesis gas (syngas) by plasma pyrolysis of the rubber powder;
a low frequency (LF) heater in fluid communication with the reaction chamber for heating unpyrolyzed rubber powder that is flowed from the reaction chamber into the low frequency induction heater to obtain carbon black;
wherein the hybrid plasma torch uses a portion of the obtained syngas as a plasma gas.

8. The apparatus of claim 7, wherein an angle between the second direction and the first direction ranges from 0° to 45°.

9. The apparatus of claim 7, further comprising a syngas collector in fluid communication with the gas outlet.

10. The apparatus of claim 9, wherein the syngas collector comprises a turbine configured to use the syngas for electricity generation.

11. The apparatus of claim 10, wherein the apparatus is powered by a portion of electricity generated from the obtained syngas.

12. The apparatus of claim 7, further comprising a carbon black collection channel in fluid communication with the LF induction heater.

13. The apparatus of claim 7, wherein the LF induction heater comprises at least one tubular conduit having a LF induction coil provided around the tubular conduit.

14. The apparatus of claim 7, wherein the tubular conduit extends outwardly from the reaction chamber at a downward angle.

15. The apparatus of claim 13, wherein the tubular conduit is rotatable about its own longitudinal axis.

16. The apparatus of claim 13, further comprising an auger rotatably provided within the tubular conduit to facilitate movement of material along the tubular conduit.

17. The apparatus of claim 13, wherein the tubular conduit is made of an inductively heatable material.

18. The apparatus of claim 16, wherein the auger is made of an inductively heatable material, wherein the tubular conduit is made of a material that allows the LF induction coil to inductively heat the auger without inductively heating the tubular conduit, and wherein the tubular conduit provides heat insulation to minimize heat loss from the auger through the tubular conduit.
